(19) United States
(12) Patent Application Publication
(10) Pub. No.: US 2010/0153372 A1
(43) Pub. Date: Jun. 17, 2010

(54) 3D VISUALIZATION SYSTEM FOR WEB SURVEY

(76) Inventor: Sea Woo Kim, Seoul (KR)

Correspondence Address: Hershkovitz & Associates, LLC, 2845 Duke Street, Alexandria, VA, 22314, US

(21) Appl. No.: 12/337,416

(22) Filed: Dec. 17, 2008

(51) Int. Cl. G06F 17/30

(52) U.S. Cl. 707/722; 707/E17.108; 707/758

(57) ABSTRACT

The present disclosure relates to a three-dimensional visualization system for internet-based web surveys which can collect in real time web articles about specific companies, products or public figures from specific websites, blogs or knowledge-search web pages, process and analyze collected articles and display survey results with a planetary system having a three-dimensional fixed star and planets such that the user can understand easily and accurately the survey results. The system can include a user interface, a database server configured to store collection conditions, a web crawler module a text classification module, an analysis engine module, a statistical evaluation module, and store rate values of the web articles and a presentation tool configured to display three-dimensional graphics of the rate values of the web articles stored in the statistical evaluation module symbolizing a planetary system having a fixed star and planets.

### BACKGROUND OF THE DISCLOSURE

1. Field of the Disclosure

The present disclosure relates to a monitoring system of a public opinion survey system with three-dimensional effects. In particular, it relates to a three-dimensional visualization system for web surveys which can collect in real time web articles about specific companies, products or public figures from specific websites, blogs or knowledge-search web pages, process and analyze collected articles and display survey results on the user's computer screen with a planetary system having a three-dimensional fixed star and planets such that the user can understand easily the survey results.

2. Discussion of Background Information

Recently, companies make lots of effort to establish a real time management system to survive in new business environments including global competitions, short term innovation cycles and customers' diverse requirements. Particularly, a company cannot survive without customers, i.e., no company can survive without markets so that they practice a customer focused management shifting from the previous customer satisfaction management. However, as there is no system providing an easy and effective way of monitoring survey results regarding prospective customers' demands and responses, only some large corporations expand lots of time and cost for collecting customer opinion data. Thus, these corporations spend lots of money unnecessarily.

In a public opinion survey field, companies conduct public opinion surveys to know preferences for specific products, popularities of public figures, national responses to current events using the internet, being away from using conventional survey documents. The internet becomes a huge and efficient information storage medium connected to networks of so many computers in the world. The internet is used for electronic mails, newsgroups, file transmissions, information searches and transmissions, electronic commercial transactions, internet financial transactions and voice and/or video communications. A commercial use of the internet is spreading by the increase of connected networks and internet users.

People set up a system including a survey website to conduct an internet-based survey. Then, users can visit the survey website and clicked on agree or disagree items with respect to a survey subject. The system counts the clicked number of “agree” or “disagree” items to provide survey results including approval and disapproval rates. However, this method requires respondents to visit the survey website.

### SUMMARY OF THE DISCLOSURE

According to the present disclosure, a three-dimensional visualization system is provided for web surveys displaying survey results with a planetary system having a three-dimensional fixed star and planets.

The visualization system described above is achieved through the present disclosure which relates to an internet-based survey system graphically displaying survey results in three-dimensions. The system can include a user interface providing a user-friendly environment for a user to input a survey subject, a database server configured to store collection conditions defined by the user and processed result data with the collection conditions, and a web crawler module configured to search directories in website search engines with the collection conditions stored in the database server and to collect web articles relating to the survey subject. A text classification module is configured to break the web articles collected into sentences and further into words in order to determine a part of speech of each word used in the web articles. An analysis engine module is configured to grade the web articles based on predetermined weight values for words, a statistical evaluation module configured to further rate the web articles graded by the analysis engine module in terms of themes and website search engines and store rate values of the web articles and a presentation tool configured to display three-dimensional graphics of the rate values of the web articles stored in the statistical evaluation module symbolizing a planetary system having a fixed star and planets.

As described above, the present disclosure can help users to easily understand the survey results and to predict the real result with respect to the survey subject by graphically displaying the survey results with the three-dimensional planetary system after searching, collecting, analyzing and assessing the web articles relating to the survey subject. Additionally, the present disclosure can improve the competence of a company and enables it to make a fast and good decision under a fast changing business environment. Consequently, the present disclosure can provide great benefits and values to both companies and customers, especially to medium and small-sized companies to improve their competitive advantages.

### BRIEF DESCRIPTION OF THE DRAWINGS

The present invention is illustrated in the accompanying drawings.

FIG. 1 is a simplified diagram illustrating the elements of the three-dimensional visualization system of the present invention.

FIG. 2 is a data search screen for web surveys of the present invention.

FIG. 3 is a perspective view of elements illustrating the steps of searching, collecting and analyzing web articles and visualizing survey results in accordance with the present invention.

FIG. 4 is a three-dimensional visualization of survey results using a planetary system in accordance with the present invention.

FIG. 5 is an exemplary illustration of a planetary system in accordance with the present invention.

FIG. 6 is a planetary system showing a rotation function included in a viewing function in accordance with the present invention.

FIG. 7 is a planetary system showing a translation function included in the viewing function in accordance with the present invention.

FIG. 8 is a planetary system showing a zoom function included in the viewing function in accordance with the present invention.

FIG. 9 is a planetary system showing a draw mode function included in the viewing function in accordance with the present invention.

FIG. 10 is a horizontal view of a planetary system in accordance with the present invention.

FIG. 11 is a vertical view of a planetary system in accordance with the present invention.

FIG. 12 is a side view of a planetary system in accordance with the present invention.

FIG. 13 is a drawing showing a display function included in the viewing function displaying survey results of a site corresponding to a selected planet with two-dimensional graphs and numbers in accordance with the present invention.

FIG. 14 (a) and FIG. 14(b) are drawings showing sub screens of FIG. 4.

FIG. 15 is a block diagram showing elements of the web crawler module, the analysis engine module, the presentation tool and the database server and relations among them in accordance with the present invention.

FIG. 16 (a) is a functional illustration of the web crawler module, FIG. 16 (b) is a functional illustration of the analysis engine module and FIG. 16 (c) is a functional illustration of the presentation tool.

### DETAILED DESCRIPTION OF PREFERRED EMBODIMENTS

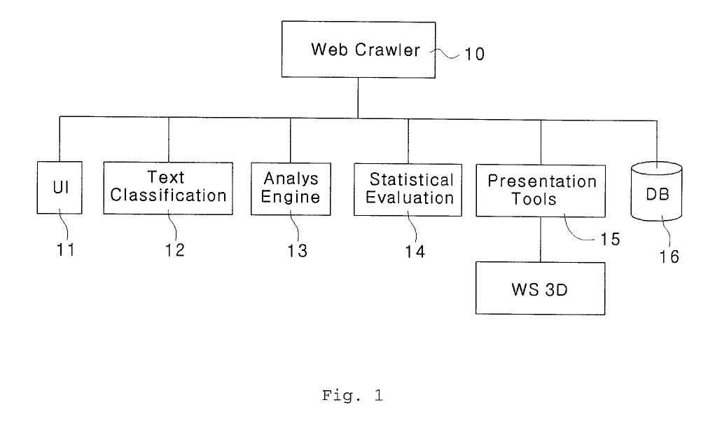

As illustrated in FIG. 1, user interface (11) can assist users to input easily survey subjects and can include a subject manager, a site rank manager, a keyword manager and a web article viewer showing collected web articles. Their functions are described as below.

The subject manager has a management screen which can choose and store a sentence of survey subject in database server (16) and manage to input the sentence automatically or semi-automatically. Inputting the sentence automatically means that if the user sets up a specific time of inputting the survey subject in the screen, the survey subject will be automatically inputted in accordance with the time set by the user and the system starts to collect web articles relating to the subject. However, inputting the sentence semi-automatically means that the system starts to collect relevant web articles when the user inputs the survey subject in the screen.

The site rank manager can manage a number of websites where web articles are searched and collected. If the number of websites are not limited by the site rank manager, then the web crawler collects web articles in all of websites available. A rank of a website search engine can be determined based on ranks provided by a professional company assessing the awareness and recognition level of websites or the user can determine the rank of the website search engine based on the user's personal assessment. Also, the user can conduct a web survey to determine the rank of the website search engine.

The keyword manager relates to managing the meanings and predeterinined weight values of words. To process natural languages, the keyword manager can work as a word dictionary for each word and it also manages the weight values for words which can be used to analyze each word.

The web article viewer enables the user to view web articles collected by the web crawler module (10) and the result of analysis of web articles on the user's local screen without connecting to the web.

The web crawler module (10) relates to identifying a survey subject to be surveyed on a specific day and the collection period of web articles stored in database server (16) and collecting web articles relating to the survey subject in the internet. As described above, websites to be searched are the ones chosen by the site rank manager of user interface (11) or the whole web. A collection program such as Web Crawler can be used for web crawler module (10).

Text classification module (12) can analyze a web article by a unit of sentence and further by a unit of word and decide a part of speech of each word in order to analyze the web article by using analysis engine module (13). Word and sentence analysis can be done by using a preexisting software application such as CORPUS.

Analysis engine module (13) can grade the web article based on weight values for words predetermined by the keyword manager of user interface module (11).

Statistical evaluation module (14) can rate the web articles graded by the analysis engine module in terms of themes and website search engines and store rate values of the web articles in database server (16).

Presentation tool (15) can display charts, two-dimensional graphics and three-dimensional graphics by using texts, numbers and figures based on the rate values of the web articles and the analysis results in terms of the kinds of websites.

As described above, the present disclosure can collect, process and analyze data information uploaded in real time on a specific website, blog and knowledge-search web page by netizens which are related to the survey subject of companies, products and public figures.

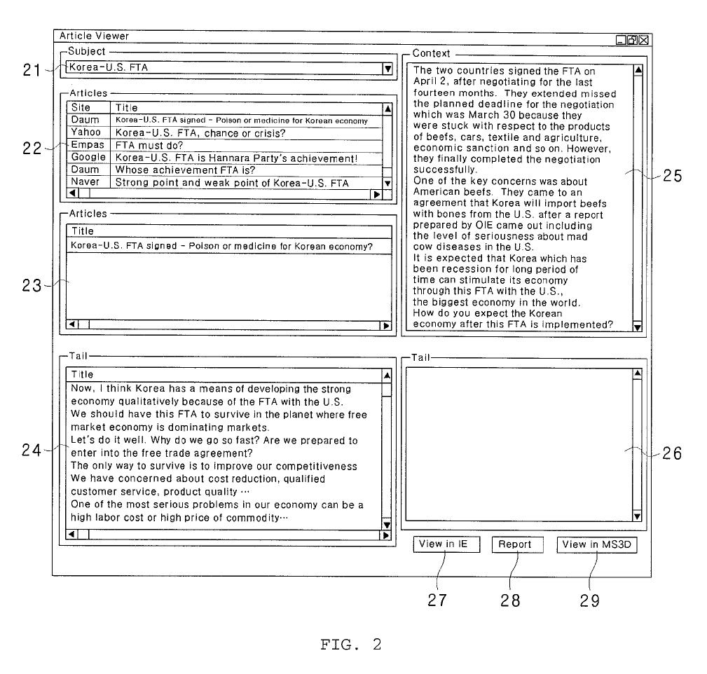

FIG. 2 illustrates a data search screen for the web survey of the present disclosure. If the user inputs questions to be asked for a survey into subject input window (21) of data search screen (20), web crawler module (10) collects information from websites, stores collected articles in database server (16) and displays relevant information on data search screen (20). FIG. 2 shows an example of the data search screen when the user inputs “Korea-USA FTA” subject into the subject input window.

Data search screen (20) can include subject input window (21) for inputting a survey subject, website display window (22) displaying website names and the headings of collected articles relevant to the survey subject, reply display window (23) displaying netizens' opinions with respect to the collected articles relevant to the survey subject, tail display window (24) displaying replies to the netizens' opinions regarding the collected articles, context display window (25) displaying the whole content of the collected article upon clicking on a specific article displayed on the website display window, selected tail display window (26) displaying selected replies among in the netizens' replies displayed on the tail display window, link button (View in IE)(27) enabling the user to link to the website where a specific article is collected, two-dimensional visualization button (28) enabling the user to display survey results in two-dimensional visualization by clicking on the button as illustrated in FIG. 14 and three-dimensional visualization button (View in WS3D) (29) enabling the user to display survey results in three-dimensional visualization by clicking on the button as illustrated in FIG. 5.

The web crawler module can collect articles once at a time relevant to an inputted survey subject, collect and renew articles periodically after storing the survey subject in the database server and collect articles for a specified period of time in accordance with a collection condition defined by the user. It is obvious for the person of ordinary skill in the art to change the collection condition based on the user's need.

The collected web article can be visualized in two-dimensions or in three-dimensions by presentation tool (15) after statistically processed using text classification module (12), analysis engine module (13) and statistical evaluation module (14).

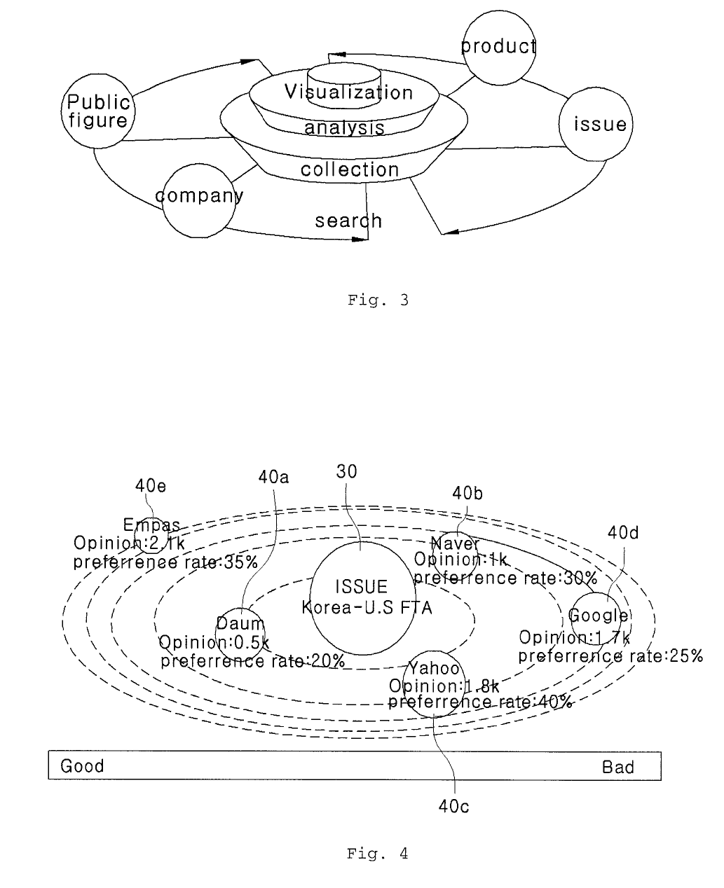

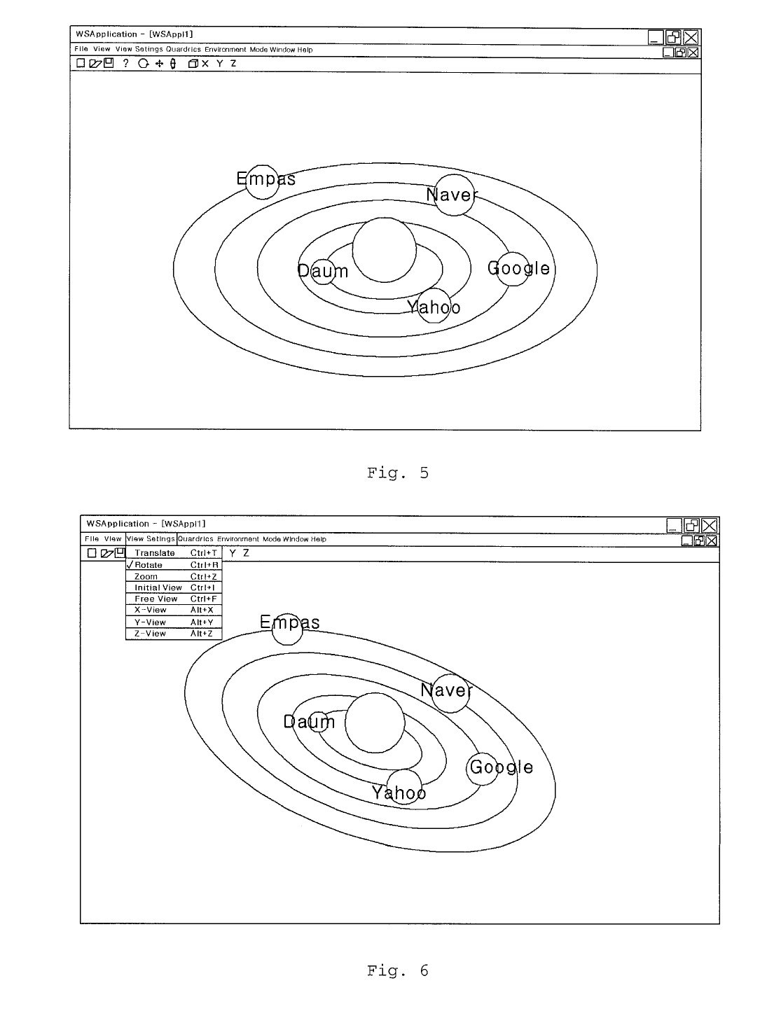

FIG. 3 is a configuration showing the steps of searching, collecting and analyzing web articles. As seen in FIG. 4, the processed data can be three-dimensionally visualized with a planetary system by presentation tool (15). Analyzed results can be displayed with center fixed star (30) for a specified survey subject and with planets (40:40 A, 40B, 40C . . . ) for each website search engine.

FIG. 4 illustrates that the analyzed results can be displayed by the distance, size, and color of the fixed star and planets.

The distance between fixed star (30) and planets (40:40 A, 40B, 40C . . . can show the recognition rank of each website search engine where articles are collected. The recognition rank can be ranks provided by a professional internet ranking site with respect to each website search engine or can be ranks determined by the user after a separate web survey. In this figure, it is understood that the higher recognition rank the search engine website has, the closer the planet corresponding to the website is to the fixed start.

The size of planet (40) can be displayed corresponding to the numbers of collected opinions. The color of planet (40) can vary according to the level of preference, for example higher in more blue and lower in more red.

As described, the present disclosure can help users to understand a public opinion tendency easier by displaying survey results corresponding to the distance, size, and color of a fixed star and planets.

In a preferred embodiment, the color of a planet can be displayed to indicate positive responses with a blue color and negative responses with a red color. However, certain contrasted colors can be used for the same purpose.

FIG. 5 illustrates an example of displaying survey results with a planetary system. If the user clicks on fixed star (30), the system can display the analyzed result data comparing websites in terms of numbers of opinions collected therefrom, approval rate, opposition rate, etc. with two-dimensional graphs and numbers as seen in FIG. 14(a). If the user clicks on a planet corresponding to a website which is placed around the fixed star, the system can display survey results based on the articles collected from the corresponding website with two-dimensional graphs and numbers as seen in FIG. 14(b). As seen in FIG. 14(b), the user can have text information, too.

In one preferred embodiment of the present disclosure, approval, opposition, undecided and filter out rates about the survey subject can be displayed in terms of each website with bar graphs as seen in the upper end of FIG. 14(a). The numbers of opinions and approval, opposition, undecided and filter out rates regarding the survey subject can be displayed in terms of each website with numbers in the lower end of FIG. 14(a). This embodiment of the present disclosure displays in a two-dimensional form using MSSQL2005, a reporting service program. Some other programs for the same purpose can be used for displaying the result. FIG. 14(a) illustrates the survey results about the survey subject of “Korea and USA Free Trade Agreement” collected from search engine websites such as Daum, Yahoo, Google, Naver and Empass. As seen in the explanatory notes of FIG. 14(a), approval, opposition, undecided and filter out rates can be displayed with blue, red, green and yellow colors respectively.

If the user clicks on the website link of the screen of FIG. 14(a), he can monitor web articles collected from each website as the same way as clicking on planets as described above. For example, if the user clicks on the underlined website Daum, the system displays the headings of articles collected from Daum website and the preference rate showing whether the public approves or disapproves the survey subject by way of counting the numbers of words having positive or negative meanings about the survey subject in the collected articles as seen in FIG. 14(b). The color of the fixed star can be decided by the preference rate and displayed as seen in FIG. 4.

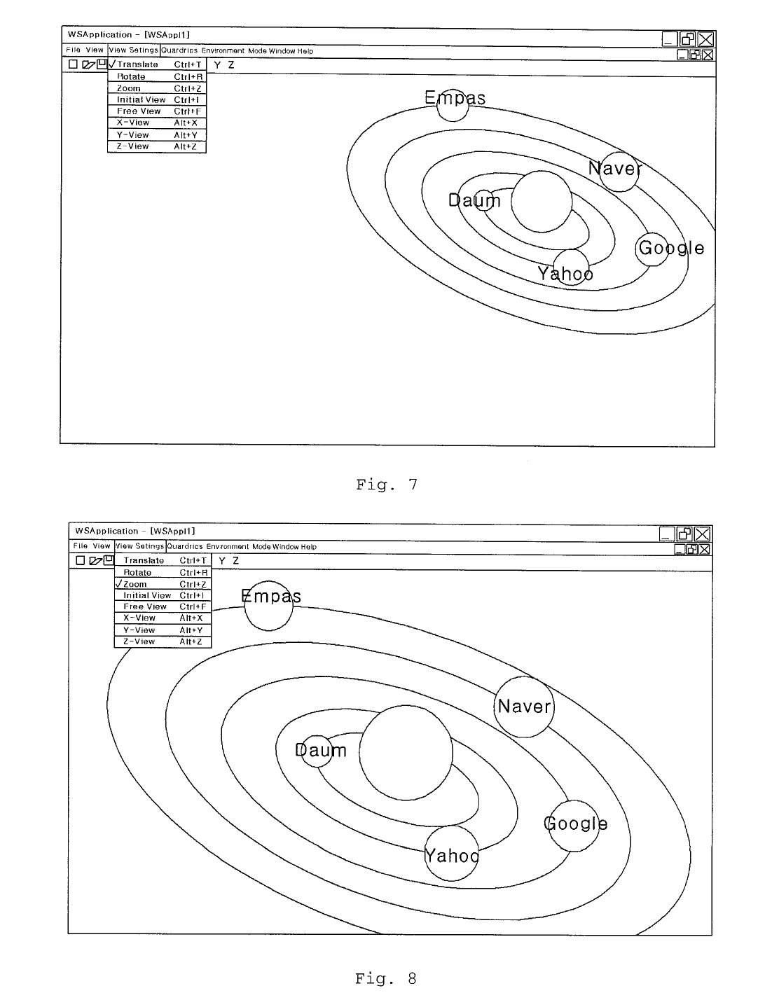

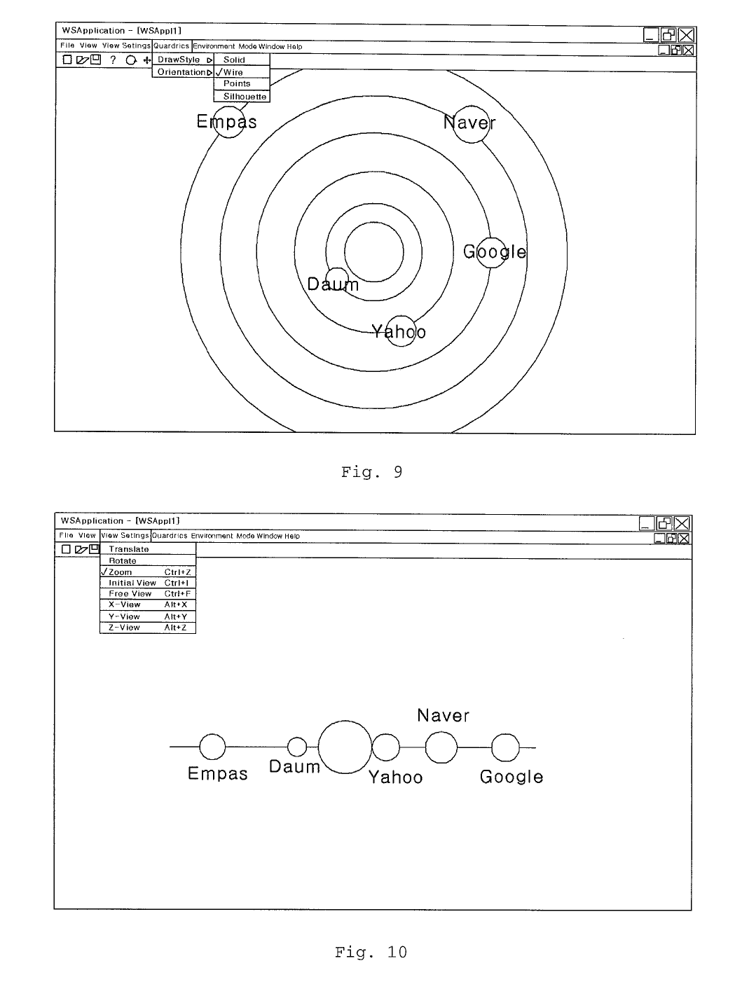

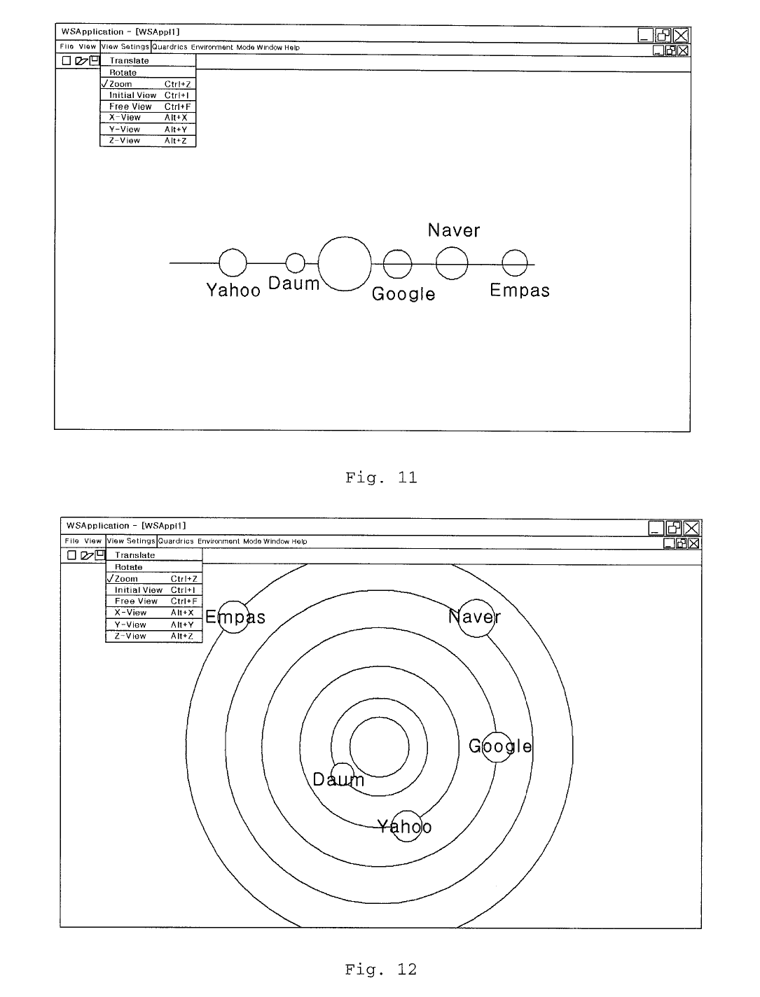

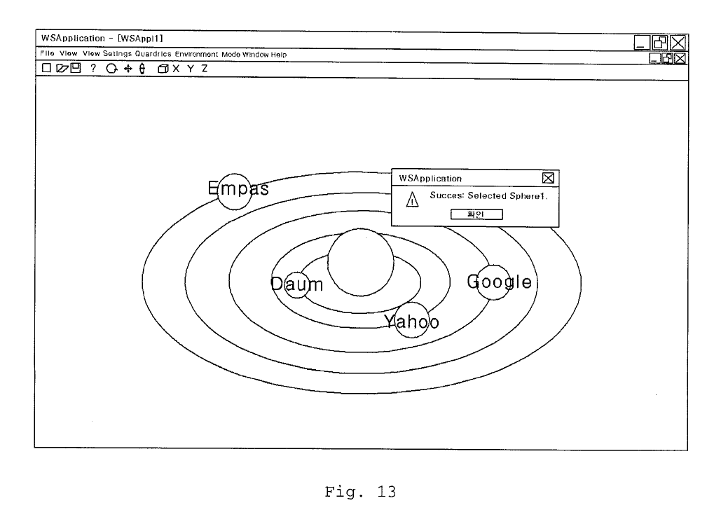

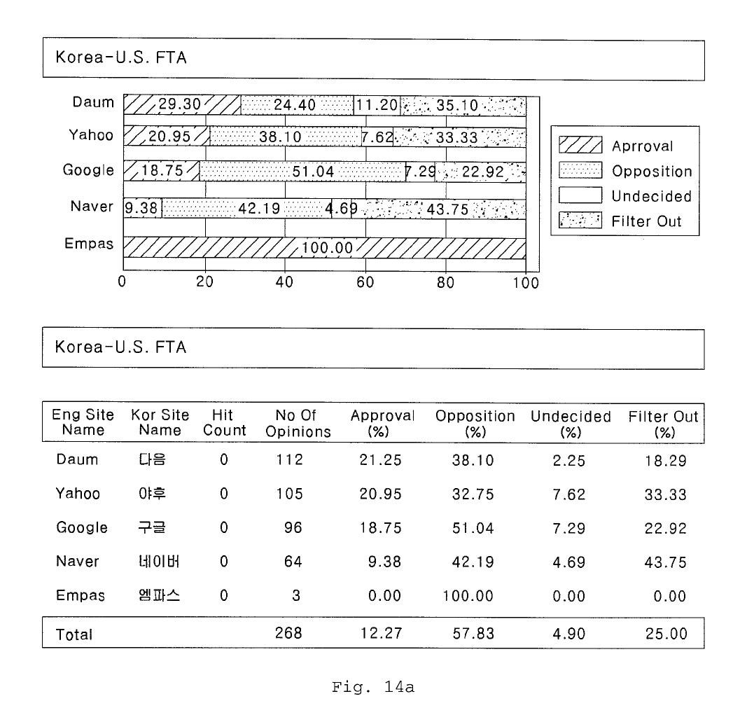

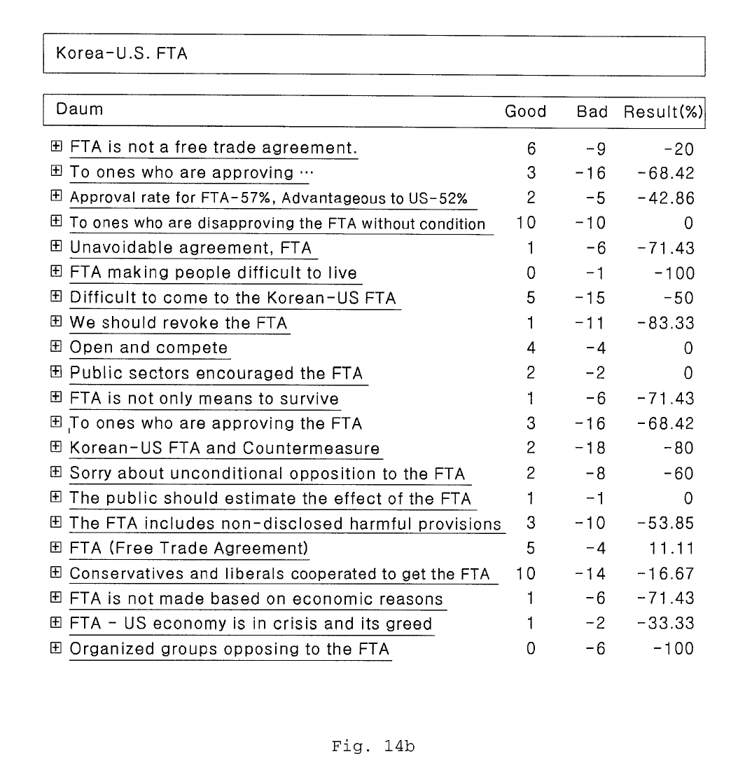

FIG. 6 illustrates that the user can rotate the planetary system upwardly, downwardly, rightwardly and leftwardly by the basic viewer tools of FIG. 5. FIG. 7 illustrates that the system has a function of moving the planetary system up, down, right and left. FIG. 8 illustrates a zoom in/out function and diverse viewing functions with respect to x, y and z axes as shown in FIG. 10, FIG. 11, and FIG. 12. The function of FIG. 8 can be practiced by using the function of FIG. 7 but this function of FIG. 8 can provide faster and accurate x, y and z axis views.

In a preferred embodiment of the present disclosure, the survey results can be displayed as a sphere-shaped unit, but they also can be displayed as other shapes such as rectangular shape, line and spot shapes. Even if the shapes can be changed to a rectangular shape, the colors do not change but are displayed as described above. When displayed with polygonal shapes, specific items can be commonly displayed with respect to every direction. For example, when the user applies a viewing function with respect to x, y and z axes, the planets corresponding to each website can be displayed as the same shapes and colors in each view with respect to x, y and z axes.

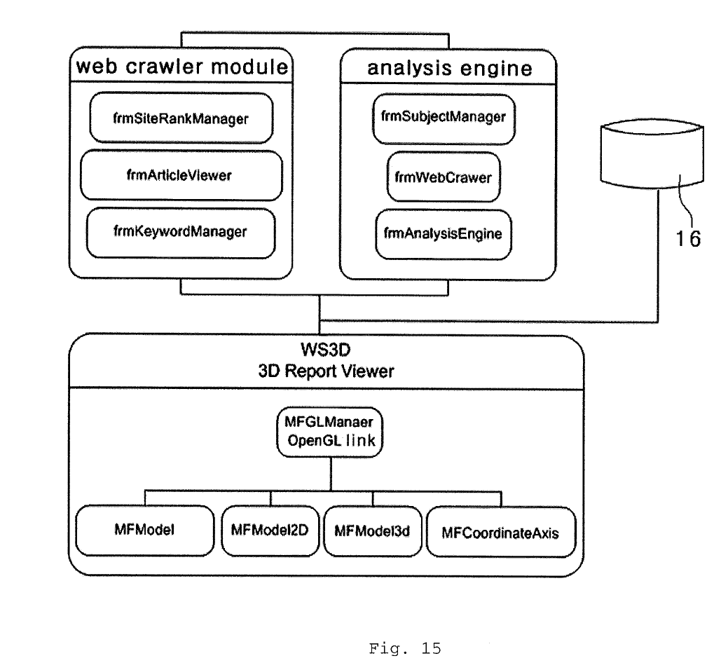

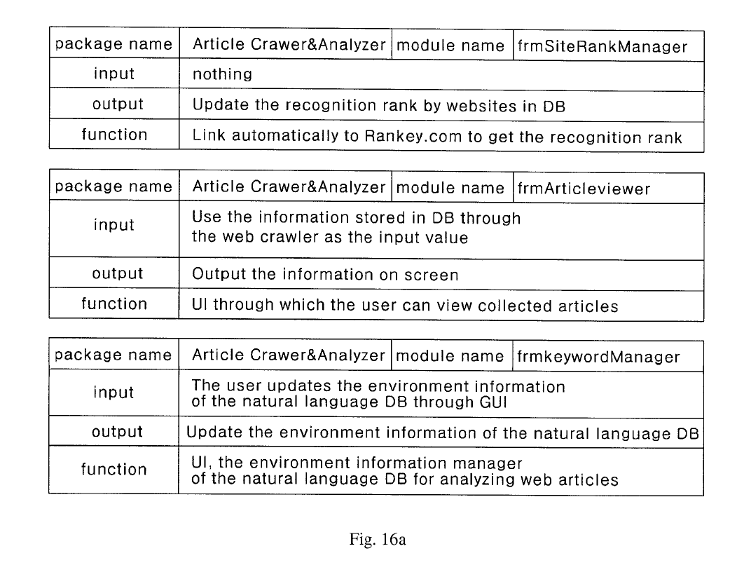

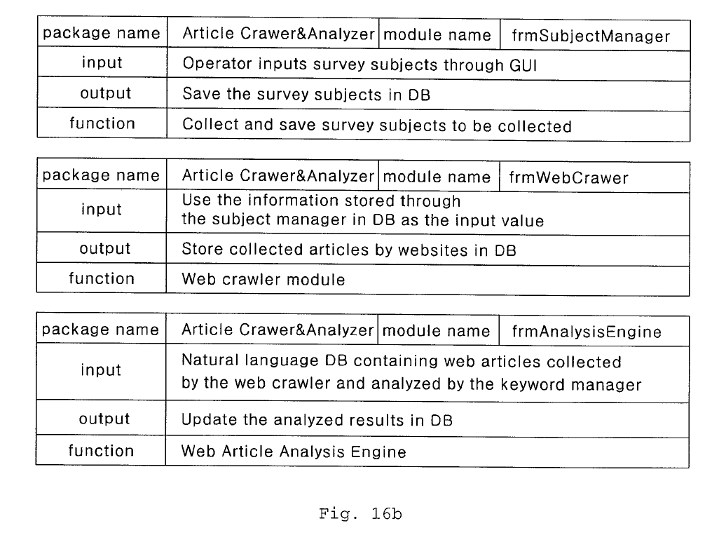

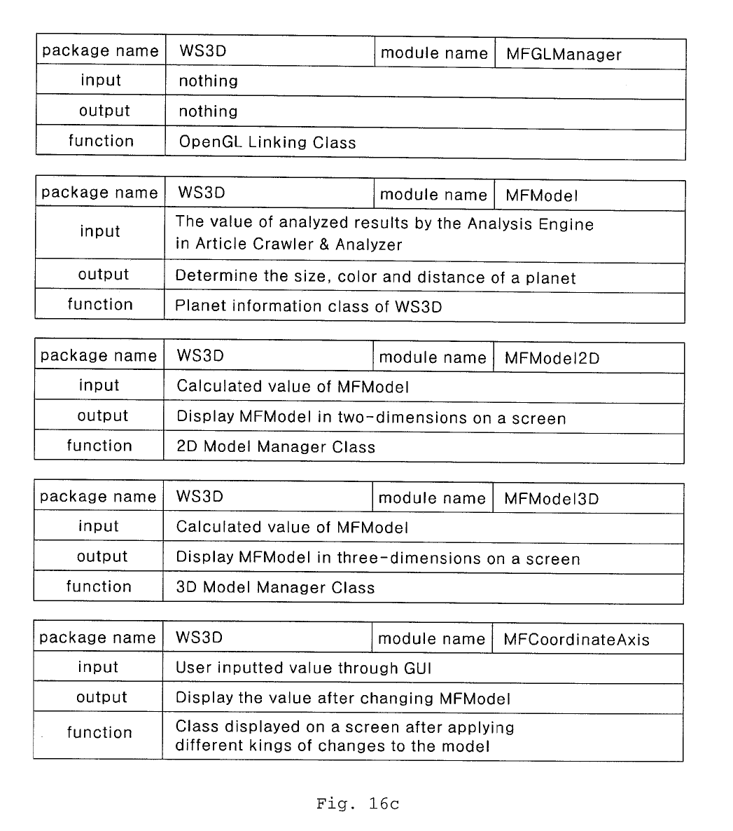

FIG. 13 illustrates a function that the user can place multiple planets into a rotating orbit and see all of the planets in the orbit at the same time. The function illustrated in FIG. 13 can be used when a fast and easy decision making with respect to the fixed star, the survey subject, is required without considering the level of awareness with respect to each website.

FIG. 15 illustrates the details of the web crawler module, the presentation tool (WS3D), the database server and relations among them.

As illustrated in the drawings, when the user chooses a certain analyzed survey subject, the database calculator (MFModel) of presentation tool (15) can fetch data information of the relevant survey subject from database server (16) and calculate specific variables for each website and the graphic generation manager (MFGLManager) can display information in the database calculator (MFModel) through the two-dimensional graphic generator (MFModel2D) or the three-dimensional graphic generator (MFModel3D). If the user applies a scale-up, a scale-down, a move or a rotation function, the model change manager (MFCondinateAxis) executes the function applied by the user and displays it accordingly.

If the user wants to get website ranks from the internet, the user can control website information through the site rank manager (frmSiteRankManager) and the website information can be stored in database server (16). If a user receives a specific survey subject from a customer, the user can register the survey subject into database server (16) through the subject manager (frmSubjectManager). The web crawler module (frmWebCrawer) can collect articles relevant to the survey subject from websites registered in the site rank manager (frmSiteRankManager) and can store collected web articles in database server (16). Web articles stored in the database sever can be seen in the form of GUI through the web article viewer (frmAiticleViewer). The user can direct the system to analyze the collected web articles through the analysis engine (frmAnalysisEngine) so that the analysis engine (frmAnalylisEngine) uses the natural language processing module registered with the keyword manager (frmKeywordManager).

What has been described are only some examples of methods and systems according to the present disclosure. Accordingly, it is to be understood that various and numerous other arrangements may be devised by one skilled in the art without departing from the spirit and scope of the present disclosure as limited only by the accompanying claims.

What is claimed is:

1. An internet-based survey system graphically displaying survey results in three-dimensions, the system comprising:
a user interface providing a user-friendly environment for a user to input a survey subject;
a database server configured to store collection conditions defined by the user and processed result data with the collection conditions;
a web crawler module configured to search directories in website search engines with the collection conditions stored in the database server and to collect web articles relating to the survey subject;
a text classification module configured to break the web articles collected into sentences and further into words in order to determine a part of speech of each word used in the web articles;
an analysis engine module configured to grade the web articles based on predetermined weight values for words;
a statistical evaluation module configured to further rate the web articles graded by the analysis engine module in terms of themes and website search engines and store rate values of the web articles; and
a presentation tool configured to display three-dimensional graphics of the rate values of the web articles stored in the statistical evaluation module symbolizing a planetary system having a fixed star and planets.

2. The internet-based survey system of claim 1, wherein the planets are displayed as a sphere-shaped or a hexahedron-shaped unit.

3. The internet-based survey system of claim 2, wherein the fixed star comprises the survey subject and the planets comprise the website search engines collecting public opinions relating to the survey subject.

4. The internet-based survey system of claim 3, wherein the planets surrounding the fixed star display a recognition rank of the website search engines by way of distances between the fixed star and the planets.

5. The internet-based survey system of claim 4, wherein the size of the planets corresponds to the number of collected opinions.

6. The internet-based survey system of claim 4, wherein the color of the planets vary according to the level of preference, higher in more blue and lower in more red.

7. The internet-based survey system of claim 1, wherein the web crawler module further comprising a site rank manager in the database server updating the rank of each website search engine, an article viewer presenting stored web articles through the user interface and a keyword manager updating a natural language database, which is used by the user to analyze web articles, through the user interface.

8. The internet-based survey system of claim 1, wherein the analysis engine module further comprises a subject manager storing the survey subject being inputted by the user through the user interface, a web crawler storing the collected articles in the database sever in terms of the website search engines and an analysis engine analyzing the collected articles stored in the database by using a natural language treatment module registered with the keyword manager.

9. The internet-based survey system of claim 1, wherein the presentation tool further comprises a database calculator determining the sizes and colors of the planets and the distances of the planets from the fixed star, a two-dimensional graphic generator displaying the values of the sizes, colors and distances of the planets determined by the database calculator on a screen in two-dimensions, a three-dimensional graphic generator displaying the values determined by the database calculator on a screen in three-dimensions, a model change manger changing visual displays of the planetary system according to input variables including a scale-up, a scale-down, a move and a rotation and a graphic generation manger displaying information contained in the database calculator through the two-dimensional and three-dimensional graphic generators.
